(19) United States
(12) Patent Application Publication
(10) Pub. No.: US 2012/0011001 A1
(43) Pub. Date: Jan. 12, 2012

(54) SYSTEM AND METHOD FOR EMBEDDED ADDRESSABLE CONTENT WITHIN TEXT AND GRAPHICS FOR DIGITAL MEDIA

(75) Inventors: Eric M. Gross, Rochester, NY (US); Peter Paul, Webster, NY (US)

(73) Assignee: Xerox Corporation, Norwalk, CT (US)

(21) Appl. No.: 12/832,158

(22) Filed: Jul. 8, 2010

(51) Int. Cl. G06Q 30/00; G06F 17/30

(52) U.S. Cl. 705/14.66; 707/769; 707/E17.014

(57) ABSTRACT

A system and method is provided for embedding variable advertising content into an electronic book including a receiver positioned about the electronic book and configured to receive information; a processor for determining whether one or more tags are present in the information received and a replacement module for replacing the one or more tags with the advertising content, the advertising content derived from profile data associated with a plurality of users.

### CROSS-REFERENCE TO RELATED U.S. APPLICATIONS

This application is related to commonly-owned U.S. Application No. 2010/0005486, filed on Jul. 2, 2008; the entire contents of this patent application incorporated herein by reference.

### BACKGROUND

The present disclosure is directed to the field of electronic books and digital media, and more specifically to a system and method for seamlessly embedding commercials/advertisements into electronic books, electronic documents, and other digital media.

An electronic book (also referred to as an “E-book”) is an electronic version of a traditional print book (or other printed material such as, for example, a magazine, newspaper, and so forth) that may be read by using a personal computer or by using an E-book reader. Unlike personal computers (PCs) or handheld computers, E-book readers deliver a reading experience comparable to traditional paper books, while adding powerful electronic features for note taking, fast navigation, and key word searches.

Additionally, advertisements are a necessary component of modern commerce. Conflicting issues are involved in advertising and include the fact that the advertiser wants to deliver a message to the consumer, so the attention of the consumer has to be captured, and that the advertiser must not present the advertisement in a way or to the extent that it hinders the reading/viewing activity of the consumer.

However, advertisers are not well served by the present “one size fits all” advertising paradigm, at least not in all situations. For example, advertisers may know very little about the ultimate end user who “consumes” their advertisement content in a given product package. Because the advertiser may not be able to readily ascertain who receives their advertisements along with a given product package, the advertiser may not know whether the ad receiver is a good candidate for purchasing the goods or services advertised. For these reasons, the advertiser may not believe that she is getting good value from their advertising dollar. A potential advertiser would likely pay a higher price to place advertisement content if the advertiser knew that the advertisement was likely to be received by an interested and receptive end user. Thus, the conventional methods of advertising do not exploit the potential capabilities in improved advertisement effectiveness that E-book systems may provide.

Accordingly, it would be desirable and highly advantageous to have an E-book or other electronic document that allows an advertiser to incorporate or embed targeted content into predetermined locations of such E-book or electronic document.

### SUMMARY

It is an aspect of the present disclosure to provide a system for embedding content into a digital media, including a receiver positioned about the digital media and configured to receive information, and a processor for determining whether one or more tags are present in the information received. The system also includes a replacement module for replacing the one or more tags with the content, the content derived from profile data associated with a plurality of users.

It is another aspect of the present disclosure to provide a method for embedding content into a digital media, including receiving information via a receiver positioned about the digital media; determining, via a processor, whether one or more tags are present in the information received; and replacing the one or more tags with the content, the content derived from profile data associated with a plurality of users.

In another aspect of the present disclosure, a system for altering content of an electronic book is presented including a first memory module for storing the content of the electronic book; a second memory module for storing a list of words; a processing module for comparing words in the electronic book to words in the list of words and then altering matching words in the electronic book in preparation for displaying them; and a display module for displaying the altered content of the electronic book.

The present disclosure also provides a computer-readable medium which stores programmable instructions configured for being executed by at least one processor for performing the methods described herein according to the present disclosure. The computer-readable medium may include flash memory, CD-ROM, a hard drive, etc.

Other features of the presently disclosed system and method for embedding content into a digital media will become apparent from the following detailed description, taken in conjunction with the accompanying drawings, which illustrate, by way of example, the presently disclosed system and method.

### BRIEF DESCRIPTION OF THE DRAWINGS

Various embodiments of the present disclosure will be described below with reference to the figures, wherein:

FIG. 1 illustrates a system diagram for server-side advertisement customization for electronic documents, in accordance with the present disclosure;

FIG. 2 illustrates a flowchart for server-side advertisement customization for the electronic documents system of FIG. 1, in accordance with the present disclosure;

FIG. 3 illustrates a system diagram for client-side advertisement customization for electronic documents, in accordance with the present disclosure;

FIG. 4 illustrates a flowchart for client-side advertisement customization for the electronic documents system of FIG. 3, in accordance with the present disclosure; and

FIG. 5 illustrates exemplary customization of electronic documents via the use of one or more tags, in accordance with the present disclosure.

### DETAILED DESCRIPTION

Referring now to the drawing figures, in which like references numerals identify identical or corresponding elements, the advertisement customization system and method in accordance with the present disclosure will now be described in detail. In the following description, well-known functions or constructions are not described in detail to avoid obscuring the present disclosure in unnecessary detail.

In the following detailed description, reference is made to the accompanying drawings, which form a part hereof, and in which is shown by way of illustration specific illustrative embodiments in which the present disclosure may be practiced. These embodiments are described in sufficient detail to enable those skilled in the art to practice the present disclosure, and it is to be understood that other embodiments may be utilized and that logical, mechanical and electrical changes may be made without departing from the scope of the disclosure. The following detailed description is, therefore, not to be taken in a limiting sense.

The present disclosure proposes a system and method for embedding (real-time or otherwise) customized content into e-books and other electronic documents. E-books targeted include at least novels, non-fiction, magazines, newspapers, and other increasingly more popular electronic documents. The customized content includes product placement advertisements, versioning, and modifications tailored specifically to the reader. The customization could be based on any characteristic of the reader that would be useful for marketing including, but not limited to: age, zip code, income, prior E-book purchases, on-line transaction and search histories, or other characteristics for targeted advertisement campaigns.

The customization system envisions a device (most commonly a handheld reader but not limited as such) from which the customer requests new e-book content from a merchant. The merchant may customize the e-book content prior to delivery to the customer by accessing databases of customer specific information and product placements. In another embodiment the customization may occur on the device, itself, in real time as the new e-book is being read, this would permit the potential use of a more recent customer specific database than the previously mentioned approach. One possible realization of this concept would require that the e-book contain special tags in locations where appropriate customizable content may be inserted. The tags may also specify which types of content would be appropriate for the particular location in the e-book. The customizing agent uses the tags to appropriately insert the variable content.

The present disclosure also proposes a system and method for embedding customized content into e-books and other electronic documents. Content could be tailored to individuals based upon their known preferences and attributes, for example changing the name of a referenced product based upon the user's past purchasing preferences (changing “Andy ordered a Pepsi®” to “Andy ordered a Coke®”). Tags would be identified where content could be changed. The content could be changed on either the server or client side depending upon the sophistication of the client side device. Benefits would include at least revenue generated from charging companies to have their content replace the existing content and/or added in, and/or charging based on the measured effectiveness of the advertisement, for example if the advertising of the item in the E-book prompted an online order.

Prior to describing the present disclosure in further detail, it will first be helpful to define various terms that will be used throughout the following discussion. For example:

The term “content,” as used in this disclosure refers to a graphic or plurality of graphics, compilation of text, a contone or halftone pictorial image, videos, sounds, or any combination or sub-combination thereof, that is capable of being output on a display device, a marker and the like, including a digital representation of such image. For example, content may be a combination of graphics, text, sounds, video, and pictures that is represented by a series of pixel values denoting the color, intensity, etc., of the particular pixels that make up the image. Thus, the “content” may refer to at least audio content, text content, and/or video content or a combination thereof. The “content” may be derived automatically and continuously from dynamically updated profile data.

The term “dynamic data” may refer to information that is asynchronously changed as further updates to the information become available. The term “dynamic” may refer to an operation that occurs at the time it is needed rather than at a predetermined or fixed time.

The term “document” may refer to a writing that provides information, the writing including text and/or images. The term “document” may include a text file, a Web page, a newsgroup posting, a picture, media, hyperlinks, etc. The document may, for example, include several areas consisting of text, and other areas consisting of images or graphics. The text, for example, may include narrative sections of some length, as well as titles and captions. The document may include “content,” as defined herein. The “document” may be an electronic document.

The term “electronic device” may refer to one or more personal computers (PCs), a standalone printer, a standalone scanner, a mobile phone, an MP3 player, audio electronics, video electronics, GPS systems, televisions, recording and/or reproducing media (such as CDs, DVDs, camcorders, cameras, etc.) or any other type of consumer or non-consumer analog and/or digital electronics. Such consumer and/or non-consumer electronics may apply in any type of entertainment, communications, home, and/or office capacity. Thus, the term “electronic device” may refer to any type of electronics suitable for use with a circuit board and intended to be used by a plurality of individuals for a variety of purposes. The “electronic device” may also be referred to as digital media. The digital media may include one or more receivers positioned about the digital media and configured to receive information from a storage database, as defined below. The term digital media may be equivalent to the term ‘electronic device.” The term digital media may refer to both portable, as well as non-portable electronic devices.

The term “module” may refer to a self-contained component (unit or item) that is used in combination with other components and/or a separate and distinct unit of hardware or software that may be used as a component in a system, such as a wireless or non-wireless communication system. The term “module” may also refer to a self-contained assembly of electronic components and circuitry, such as a stage in a computer that is installed as a unit.

The term “application” in the disclosed embodiments refers to a program designed for end users of a computing device, such as a word processing program, a database program, a browser program, a spreadsheet program, a gaming program, and the like. An application is distinct from systems programs, which consist of low-level programs that interact with the computing device at a very basic level, such as an operating system program, a compiler program, a debugger program, programs for managing computer resources, and the like.

The term “storage” may refer to data storage. “Data storage” may refer to any article or material (e.g., a hard disk) from which information is capable of being reproduced, with or without the aid of any other article or device. “Data storage” may refer to the holding of data in an electromagnetic form for access by a computer processor. Primary storage is data in random access memory (RAM) and other “built-in” devices. Secondary storage is data on hard disk, tapes, and other external devices. “Data storage” may also refer to the permanent holding place for digital data, until purposely erased. “Storage” implies a repository that retains its content without power. “Storage” mostly means magnetic disks, magnetic tapes and optical discs (CD, DVD, etc.). “Storage” may also refer to non-volatile memory chips such as flash, Read-Only memory (ROM) and/or Electrically Erasable Programmable Read-Only Memory (EEPROM). The “data storage” may also refer to a memory module. Memory modules may be used to store content to be embedded into pre-stored information.

Embodiments will be described below while referencing the accompanying figures. The accompanying figures are merely examples and are not intended to limit the scope of the present disclosure.

Consider the electronic book and other elements of digital reading. One enabling technology is the Amazon® Kindle™, a software and hardware platform for rendering and displaying electronic books and other reading items that is supported by a number of platforms such as Windows®, iPhone® OS, BlackBerry®, and Mac® OS X. The electronic reading of books, in particular, is expected to significantly impact the sales of actual books and is a growing industry. Electronic media such as this offers unprecedented opportunity for addressable advertising in books by text and image modification.

The embedded marketing may include that of text and/or pictures/graphics and would either be “blind” (inserting the same variable content into all e-books) or based on customer specific information such as known purchasing habits, credit history, age, zip code, income, etc., that may even be available from information stored in the device itself. In an e-book, for example, the main story line is to be kept intact with slight modifications to incorporate directly or indirectly the sales promotion. Customers may even have a choice to opt for such modified versions in exchange for a reduced price or other incentives. This is in some ways similar to purchasing an “abridged” edition as opposed to the original. New revenue streams are generated from selling advertisement space in the e-books.

The following are non-limiting examples illustrating the concepts of the present disclosure.

### Example 1

### Replacement of Text

Suppose a customer has purchased the text electronically from the novel “The Da Vinci Code,” by Dan Brown.

In the text the following is actually written:

“She glanced playfully at Langdon, who was seated onstage. “An audience member has just handed me a far more, shall we say . . . intriguing introduction.”

She held up a copy of Boston Magazine.”

The last sentence could be altered for a reader closely affiliated with Rochester, N.Y. so that it reads:

She held up a copy of “The Democrat and Chronicle,”

Or for a reader in Cleveland, Ohio it might read:

She held up a copy of “The Cleveland Plain Dealer,”

The Cleveland Plain Dealer may pay a fee for each time it is presented or some other financial arrangement may be agreed upon.

One mechanism used for replacing such content would be by tagging the content within the original text that is replaceable and linking that text to acceptable contextual substations as well if available, a decision mechanism that takes into account spending habits, gender, location, etc., as well as information from marketing entities as to what type of individuals they wish to target.

### Example 2

### Insertion of Text

Another example is described from children's literature. In the book “Captain Underpants,” by Day Pilkey, a character states that:

“Most super heroes look like they are flying around in their underwear,” he said. “Well, this guy actually is flying around in his underwear!”

This may be altered based on purchasing habits or otherwise to read:

“Most super heroes look like they are flying around in their Fruit of the Loom® underwear,” he said. “Well, this guy actually is flying around in his Fruit of the Loom® underwear!”

In addition, the logo may also be inserted in the text, or an illustration could be altered such that the Fruit of the Loom® logo is inserted onto the characters underwear.

### Example 3

### Insertion of Text

A third example is where text that was not in the original document is inserted for product placement purposes, without undue distraction away from the storyline. From page 1 of Tom Clancy's “Without Remorse:”

“ . . . She'd just been standing at the side of the road, watching the cars speed past in a spray of highway grit and a wake of fumes. Her posture was that of a hitchhiker, one knee locked, the other bent. She held a Coca-cola® in one hand. Her clothes were clearly well used and a backpack was loosely slung over one shoulder . . . . ”

The text in bold was added to the original as a product placement. Depending on the demographic profile of the reader, Coca-cola® might be replaced by Dasani® bottled water, Diet Coke®, or Minute Maid® Lemonade (all Coca-Cola® brands, though not necessarily limited as such). Further, the variable data text may be replaced by Coca-Cola® brands that are local to the reader's country. The text font could be altered to be the brand's font or the logo itself could be placed within the text.

### Example 4

### Version Text

A fourth example is where words, paragraphs, sections, or chapters are masked or excised from the text based on the custom profile of the reader. In particular, a G-rated version of the eBook may be preferred by the reader with certain (customized) specific words masked by symbols, as in “ . . . what the %&$#& is wrong with you? . . . . ” Sections may also be replaced by summaries. Therefore, the content need not necessarily be advertising. The content may potentially refer to non-advertising materials in certain applications.

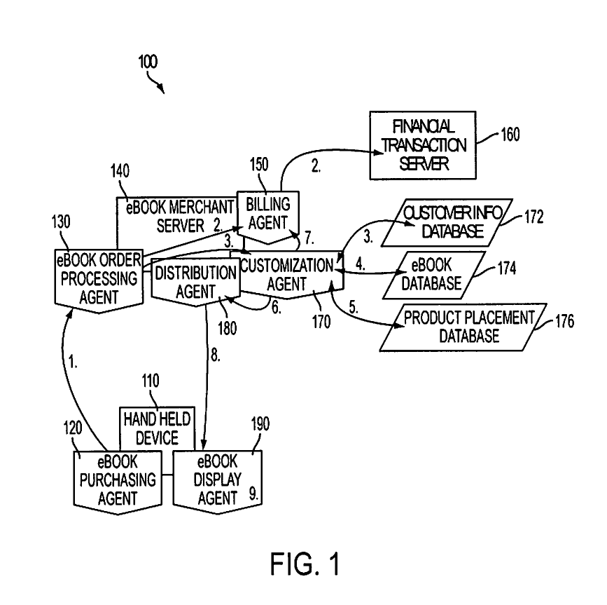

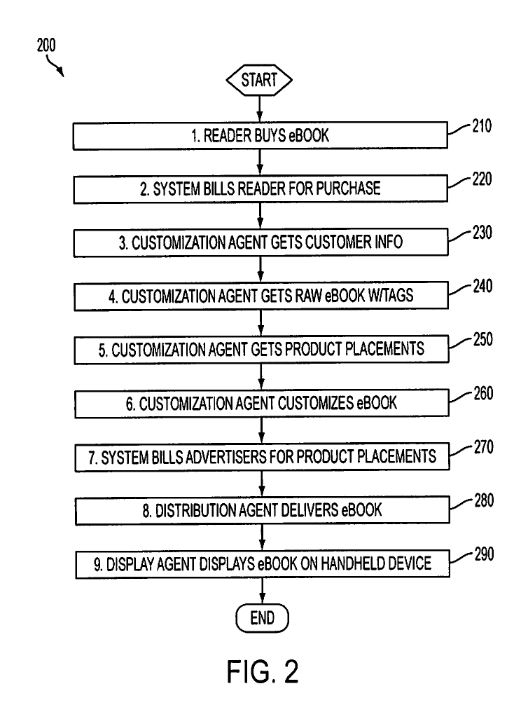

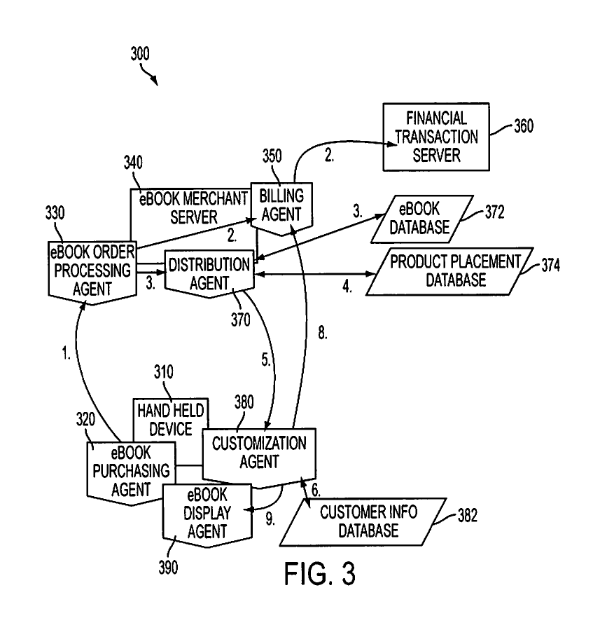

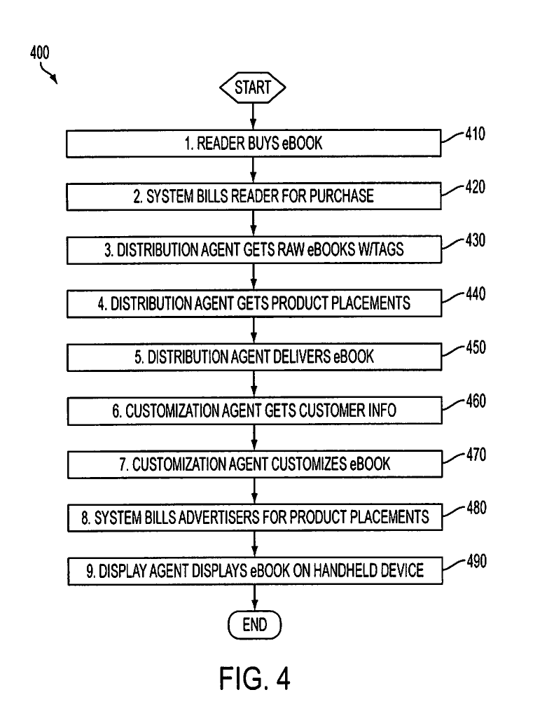

Descriptions of two sample embodiments are provided that enable at least the 4 examples presented above. The distinguishing feature of the two embodiments is the location where the customization occurs. This distinction has implications in terms of implementation details, but they are essentially two embodiments of the same basic concept. These embodiments are meant to be exemplary and are not meant to be limiting. FIGS. 1 and 2 refer to the first embodiment and FIGS. 3 and 4 refer to the second embodiment. The first embodiment of FIGS. 1 and 2 refer to server-side customization, whereas FIGS. 3 and 4 refer to client-side customization.

Referring to FIG. 1, a system diagram for server-side advertisement customization for electronic documents, in accordance with the present disclosure is presented.

The system 100 depicts a hand-held device or electronic device 110, which communicates with an eBook purchasing agent 120. The eBook purchasing agent 120 communicates with an eBook order processing agent 130 who then communicates with an eBook merchant server 140 or a billing agent 150. The billing agent 150 communicates with a financial transaction server 160.

Additionally, the eBook order processing agent 130 communicates with a customization agent 170 who then may communicate with a distribution agent 180. The customization agent 170 may interact with a customer information database 172 and/or an eBook database 174 and/or a product placement database 176. Once the customization agent 170 receives a user's personal information, the distribution agent 180 sends the customization information/data to an eBook display agent 190.

Thus, in a first embodiment, FIG. 1 shows an illustrative architecture for a server-side customization embodiment of the present disclosure. The hand held reader device or electronic device 110 performs the purchasing and displaying functions, while the server applications 140, 160 perform order processing, billing, customization, and distribution.

Referring to FIG. 2, a flowchart for server-side advertisement customization for the electronic documents system of FIG. 1, in accordance with the present disclosure is presented.

The flowchart 200 provides the following steps. In step 210, a reader purchases an eBook. In step 220, the system bills the reader for the purchase of the eBook. In step 230, a customization agent obtains customer information. In step 240, the customization agent obtains a “raw” or original eBook including a plurality of tags. In step 250, the customization agent obtains product placement. In step 260, the customization agent customizes the eBook in accordance with predetermined customer data. In step 270, the system bills the advertisers for the product placements. In step 280, the distribution agent delivers the eBook to the user. In step 290, the display agent displays the eBook to the users electronic device. The process then ends. Of course, the process then ends for the first cycle or first iteration. However, the process may be a continuous iterative process. In other words, the steps of the process may repeat for a number cycles or iterations, where at least the billing, customizing, and updating steps are constantly repeated.

In summary, the method starts by the user selecting an e-book for purchase from the, for example, e-book merchant's website. The e-book merchant's server then bills the user's account for the e-book. The customization of the e-book is then performed (before it is received by the user). The customer's marketing information is located on a database that the e-book merchant has access to. Note that this may be located on an internal or an external network. The customer's information may be aggregated at a third party's location and purchased or rented on demand. Appropriate product placement based on both the e-book chosen and the particular customer is then retrieved. The customization agent then replaces or inserts the product placement advertisements within the text and graphics of the e-book based on tags within the e-book and the customer's information. The advertisers are then billed for the product placement ads. The book is then distributed to the user and then displayed on their screen. The server-side customization approach would be preferable when a low cost simple hand held device is used. Further, it allows the e-book merchant the most control over the customer information database and allows for easier upgrades to the customization agent.

Referring to FIG. 3, a system diagram for client-side advertisement customization for electronic documents, in accordance with the present disclosure is presented.

The system 300 depicts a hand-held device or electronic device 310, which communicates with an eBook purchasing agent 320. The eBook purchasing agent 320 communicates with an eBook order processing agent 330 who then communicates with an eBook merchant server 340 or a billing agent 350. The billing agent 350 communicates with a financial transaction server 360.

In contrast to FIG. 1, the eBook order processing agent 330 next communicates with the financial transaction server 360. The eBook order processing agent 330 also communicates with the distribution agent 370 (all before customization occurs). The distribution agent 370 may also interact with an eBook database 372 and a product placement database 374. The distribution agent 370 then sends all the requested information to the customization agent 380. The customization agent 380 is located on the client side (in contrast to FIG. 1, where the customization agent 170 was located on the server side). The customization agent 380 interacts with a customer information database 382 in order to obtain personal information relates to the user who purchased the eBook. The customization agent 380 then communicates with the eBook display agent 390 to display the purchase eBook with the customized information associated with the user.

Therefore, in addition to having the customization functionality on the server, it may also occur on the hand held device. Here the hand held device is responsible for placing the order, receiving the e-book and appropriate product placement options, customizing the e-book based on locally stored customer information, and then displaying the e-book. The e-book merchant's server application is responsible for booking the order, billing the customer, retrieving the e-book and the product placement options, delivering the e-book and product placement options to the hand held device, and billing the advertisers.

Referring to FIG. 4, a flowchart for client-side advertisement customization for the electronic documents system of FIG. 3, in accordance with the present disclosure is presented.

The flowchart 400 provides the following steps. In step 410, a reader purchases an eBook. In step 420, the system bills the reader for the purchase of the eBook. In step 430, the distribution agent obtains the “raw” or original eBook with tags. In step 440, the distribution agent obtains product placements. In step 450, the distribution agent delivers the eBook. In step 460, the customization agent receives the customer information. In step 470, the customization agent customizes the eBook at the client side. In step 480, the system bills the advertisers for product placements. In step 490, the display agent displays the eBook on the hand held device or electronic device of the user. The process then ends. Of course, the process then ends for the first cycle or first iteration. However, the process may be a continuous iterative process. In other words, the steps of the process may repeat for a number cycles or iterations, where at least the billing, customizing, and updating steps are constantly repeated.

In summary, the user first buys the e-book with the price possibly a function of the degree of advertising or modification that the customer accepts. The system then bills the user for the purchase. The raw e-book with the tags is then retrieved along with the product placement options. Note that at this point, only product placement options are defined. It is not until the final customization that the final product placement ads are selected. The set of options could be a suit of brands for beverages for example where a single company owns all the brands (Coke®, Diet Coke®, Coke One®, etc.).

The final selection of which product brand is placed in the e-book is done on the hand held device either all at once, or as the pages are turned in real time, dynamically, in an automatic and continuous manner. The product placement options are selected based on the e-book chosen and the tags within the e-book. They may be selected so as to be topical with respect to the e-book's content. For example, if the e-book story is placed in an exotic locale, a product placement advertisement for an airline company or a cruise ship company might be appropriate. The particular cruise line selected for the product placement would be chosen based on the customer information (some cruise ship lines are marketed to younger people, some to older people, some to people with specific interests, etc.).

The “raw” or original e-book with tags and the product placement options are then sent to the hand held device. The customization agent on the hand held device then accesses the local database of customer information to make the final product placement selections and create each page of the e-book. The local database of customer information may be controlled by the user allowing for a custom user profile or it may be controlled by the e-book merchant completely transparent to the user. The customer information is periodically updated. The pages are then displayed on the hand held device's screen.

As a result, the client-side customization approach allows for dynamic, real-time customization of e-book pages based on the latest customer information. This may include updates based on recent customer purchasing actions that are likely linked to the advertisements that are embedded. This form of adaptive learning can possibly improve the effectiveness of the ad targeting strategy. Furthermore a component of the cost charged to the advertiser can be a function of the measured effectiveness of the ad, i.e., if it is likely the ad elicited a desired response on the part of the recipient.

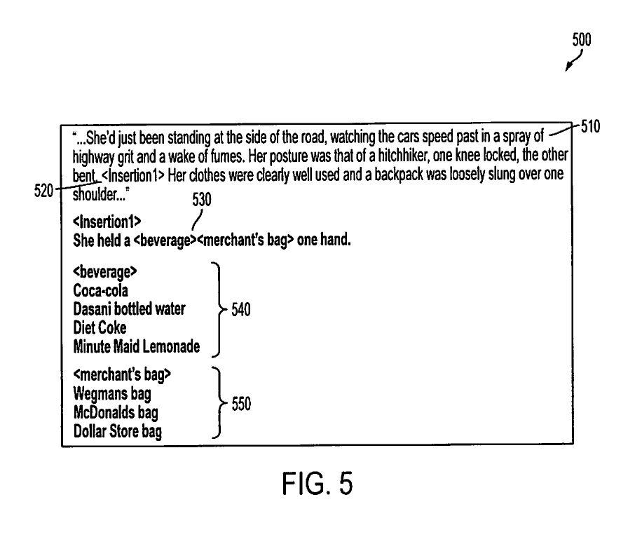

Referring to FIG. 5, exemplary customization of electronic documents via the use of one or more tags, in accordance with the present disclosure is presented.

The customization tag 500 depicts a passage 510. The passage 510 includes a tag 520. The tag 520 may be a word or a sentence or a sequence of words. For example the tag 520 may be a sequence of words 530. The sequence of words 530 may be <beverage> and <merchant's bag.> The word <beverage> may be replaced with an advertised beverage included in a list 540. The word <merchant's bag> may be replaced with an advertised bag included in a list 550. The advertised beverage and the advertised bag refer to beverages and bags that the user of the eBook prefers. This list is composed from a database that collects such personal information associated with the user.

One aspect of the present disclosure is the use of metadata in terms of tags on words, sentences, paragraphs, sections, or whole chapters to indicate where customization may occur and to describe appropriate product placement content. An example of tags in an e-book is shown in FIG. 5. The tags are used by the customization agent to replace, insert, or delete text or graphics in the e-book. The tags should have a hierarchy which depicts the appropriate type of product placement based on the content of the e-book, as well as specific product placement options. Thus, the one or more tags indicate portions of the information received from the database to be replaced with predetermined content. The content may be predetermined and may be inserted at the time of purchase or may be updated in real-time as the user utilizes the eBook or any other type of electronic document.

In addition, there are various methods by which tags are created that may be classified as either manual or automated. Manual tag creation would be performed by the author or editors to select sections that are candidates for alteration (e.g., deletion, replacement, etc.) and would apply a code that when matched with database content, would identify suitable substitutions in accordance with grammatical and semantic constraints. An automatic, or tag-less approach, based on computational linguistics may also be considered. Computational linguistics is the field concerned with developing algorithms for processing language data. The approach is often based on statistical and rule-based models. These systems understand the grammar of word forms, the grammar of sentence structure, and vocabulary. In this way words in text may be identified as belonging to a particular part of speech based on its definition and context. Once identified, it is proposed that substitutions or deletions of content be made in conjunction with a database of customer purchasing habits, gender, age, etc.

A replacement module may be composed to selectively replace the one or more tags with advertising content. All of the content may be derived from profile data associated with a plurality of users. The profile data may be associated with past historical data or with future, anticipated historical data. Moreover, the information gathered may be stored separately in a local or remote database for further processing. This may be a unique database designed solely for storing and analyzing such different types of data. Also, once a history of preferences is collected and stored for each of the plurality of users of the eBooks, such that history information may be evaluated in the future for determining which preferences may be desired in the future. In other words, the preferences may be stored and later compared against each other and ranked in order of most likely to be preferred in the future or least likely to be preferred in the future. In other words, the system is capable of making future predictions of a user's preferences.

In summary, the present disclosure relates to a method for customizing content in e-books, including product placement advertising. The present disclosure also relates to proposed architectures for customized content in e-books, as well as a proposed hierarchical data structure using tags for customized content in e-books.

Some of the advantages of the present disclosure include at least enabling new revenue streams in the e-book industry, enabling targeted marketing without interrupting the text flow on e-books, enabling targeted marketing with minimal impact on user experience in e-books, and enabling audiences with specific sensitivities to enjoy a wider variety of e-books. Personalization often enhances enjoyment and assists in the customer relating to the story line.

The following discussion is intended to provide a brief, general description of suitable computing environments in which the method and system may be implemented. Although not required, the method and system are described in the general context of computer-executable instructions, such as program modules, being executed by a printer or single computer or an MFD (multi-functional device) or a server or a plurality of processors for running the processing algorithm or an electronic device. Generally, program modules include routines, programs, objects, components, data structures, etc., that perform particular tasks or implement particular abstract data types. Moreover, those skilled in the art will appreciate that the method and system may be practiced with other computer system configurations, including hand-held devices, multi-processor systems, microprocessor-based or programmable consumer electronics, networked PCs, minicomputers, mainframe computers, MFDs, electronic devices, and the like. The method and system may also be practiced in distributed computing environments where tasks are performed by remote processing devices that are linked through a communication network. In a distributed computing environment, program modules may be located in both local and remote memory storage devices.

Additionally, “code” as used herein, or “program” as used herein, is any plurality of binary values or any executable, interpreted or compiled code which may be used by a computer or execution device to perform a task. This code or program may be written in any one of several known computer languages. A “computer,” as used herein, may mean any device which stores, processes, routes, manipulates, or performs like operation on data. A “computer” may be incorporated within one or more printers or MFDs or servers or electronic devices to operate one or more processors to run the processing algorithm. It is to be understood, therefore, that this disclosure is not limited to the particular forms illustrated and that it is intended in the appended claims to embrace all alternatives, modifications, and variations which do not depart from the spirit and scope of the embodiments described herein. The codes or programs may be associated with at least one processor for determining whether one or more tags are present in the information received to be customized.

The eBook and/or electronic devices may be connected, either directly or wirelessly, to a local computing device, which may comprise a PC or a remote computing device, which may comprise a server, via a network. In addition, the local computing device may further provide a means for displaying options to the user. Where used, the network typically comprises one or more sub-networks that are communicatively coupled to each other. By way of example, these networks may include one or more local area networks (LANs) and/or wide area networks (WANs).

Further, although aspects of the present disclosure have been described herein in the context of several particular implementations in particular environments for particular purposes, those of ordinary skill in the art will recognize that its usefulness is not limited thereto and that the present disclosure may be beneficially implemented in any number of environments for any number of purposes.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for embedding advertising content into an electronic book, the system comprising:
a receiver positioned about the electronic book and configured to receive information;
a processor for determining whether one or more tags are present in the information received; and
a replacement module for replacing the one or more tags with the advertising content, the advertising content derived from profile data associated with a plurality of users.

2. The system according to claim 1, wherein the advertising content is one of: audio content, video content, image content, and text content or a combination thereof.

3. The system according to claim 1, further comprising a memory module for storing the advertising content to be embedded into the information.

4. The system according to claim 1, wherein the electronic book includes a display unit for displaying the information with the advertising content embedded therein.

5. The system according to claim 1, wherein the electronic book is one of a portable and non-portable electronic device.

6. The system according to claim 1, wherein the profile data include at least one or more of the following: age, gender, geographic location, income, spending habits, prior purchases, on-line transactions, search histories, and favorite items.

7. The system according to claim 1, wherein the advertising content is customized prior to delivery to a user of the plurality of users.

8. The system according to claim 1, wherein the advertising content is customized in real-time as the information is being viewed by a user of the plurality of users.

9. The system according to claim 1, wherein the advertising content is derived automatically and continuously from dynamically updated profile data.

10. A method for embedding advertising content into an electronic book, the method comprising:
receiving information via a receiver positioned about the electronic book;
determining, via a processor, whether one or more tags are present in the information received; and
replacing the one or more tags with the advertising content, the advertising content derived from profile data associated with a plurality of users.

11. The method according to claim 10, wherein the advertising content is one of: audio content, video content, image content, and text content or a combination thereof; and

12. The method according to claim 10, wherein the profile data include at least one or more of the following: age, gender, geographic location, income, spending habits, prior purchases, on-line transactions, search histories, and favorite items.

13. The method according to claim 10, further comprising storing the advertising content to be embedded into the information in a memory module.

14. The method according to claim 10, further comprising displaying the information with the advertising content embedded therein on a display unit of the electronic book.

15. The method according to claim 10, wherein the electronic book is one of a portable and non-portable electronic device.

16. The method according to claim 10, further comprising customizing the advertising content prior to delivery to a user of the plurality of users

17. The method according to claim 10, further comprising customizing the advertising content in real-time as the information is being viewed by a user of the plurality of users.

18. The method according to claim 10, further comprising automatically and continuously deriving the advertising content from dynamically updated profile data.

19. A system for altering content of an electronic book, the system comprising:
a first memory module for storing the content of the electronic book;
a second memory module for storing a list of words;
a processing module for comparing words in the electronic book to words in the list of words and then altering matching words in the electronic book in preparation for displaying them; and
a display module for displaying the altered content of the electronic book.

20. The system according to claim 19, wherein the processing module alters the matching words by replacing characters with different characters or with graphical symbols.

21. The system according to claim 19, wherein the list of words is protected by a password.

22. A method for altering content of an electronic book, the method comprising the steps of:
storing the content of the electronic book in a first memory module;
storing a list of words in a second memory module;
comparing words in the electronic book to words in the list of words, via a processing module;
altering matching words in the electronic book in preparation for displaying them; and
displaying the altered content of the electronic book via a display module.
